(19) United States
(12) Patent Application Publication
(10) Pub. No.: US 2006/0109914 A1
(43) Pub. Date: May 25, 2006

(54) Method and apparatus for preventing error propagation in a video sequence

(76) Inventors: Purvin Bibhas Pandit, Somerset, NJ (US); Jill MacDonald Boyce, Manalapan, NJ (US)

Correspondence Address: THOMSON LICENSING INC., PATENT OPERATIONS, PO BOX 5312, PRINCETON, NJ, 08543-5312, US

(21) Appl. No.: 10/542,668

(22) PCT Filed: Jan. 23, 2004
(86) PCT No.: PCT/US04/01781

§ 371 Date: Jul. 18, 2005

(30) Foreign Application Priority Data
Jan. 23, 2003 (US) 62442110

(51) Int. Cl. H04B 1/66; H04N 7/12; H04N 11/02; H04N 11/04

(52) U.S. Cl. 375/240.27; 375/240.24; 375/240.16; 375/240.12

(57) ABSTRACT

A method for constructing a sequence of video pictures is disclosed. A region of a video picture that is supposed to be used as a predictor to construct a block corresponding to a second picture in a video sequence is ignored when an error correction technique is used to construct the predictor region. The invention applies information corresponding to a region from an alternative picture in the video sequence as replacement for the predictor region. This replacement information is then used as the basis to predictively construct the block in accordance with a video decoding operation.

### FIELD OF THE INVENTION

This invention relates towards the field of correcting errors in a sequence of video pictures for a decoding operation.

### BACKGROUND OF THE INVENTION

With the development of communications networks (network fabric) such as the Internet and the wide acceptance of broadband connections, there is a demand by consumers for video and audio services (for example, television programs, movies, video conferencing, radio programming) that can be selected and delivered on demand through a communication network. Video services, referred to as media objects or streaming audio/video, often suffer from quality issues due to the bandwidth constraints and the bursty nature of communications networks generally used for streaming media delivery. The design of a streaming media delivery system therefore must consider codecs (encoder/decoder programs) used for delivering media objects, quality of service (QoS) issues in presenting delivered media objects, and the transport of information over communications networks used to deliver media objects, such as audio and video data delivered in a signal.

Codecs are typically implemented through a combination of software and hardware. This system is used for encoding data representing a media object at a transmission end of a communications network and for decoding data at a receiver end of the communications network. Design considerations for codecs include such issues as bandwidth scalability over a network, computational complexity of encoding/decoding data, resilience to network losses (loss of data), and encoder/decoder latencies for transmitting data representing media streams. Commonly used codecs utilizing both Discrete Cosine Transformation (DCT) (e.g., H.263+) and non-DCT techniques (e.g., wavelets, integer transforms, and fractals) are examples of codecs that consider these above detailed issues. Codecs are also used to compress and decompress data because of the limited bandwidth available through a communications network.

Commonly used video based codecs for standards such as MPEG-2 (Motion Picture Standards Group Standard ISO/IEC 13818-1:2000) and ITU-T H.264/MPEG AVC (ISO/IEC 14496-10) compress video data into a sequence of video pictures or pictures that utilize techniques as intra-frame and inter-frame encoding, as known in the art. When inter-frame encoding is performed, each sequence of video pictures will have at least one reference picture that is used as the basis to construct the other pictures in the video sequence using other video data and coding techniques according to a selected video standard. In addition, video codecs use a technique called error concealment to cover up errors in received data of a video picture where data from a reference picture is used to conceal or replace the faulty data in such a video picture.

When data is used from a reference picture for the purposes of error concealment, the data of the reference picture itself may be incomplete or corrupted. Hence, a codec may unintentionally use corrupted data from a reference picture to generate other pictures in a sequence of video pictures, where the corrupted data causes further errors to propagate among the generated pictures. Accordingly, it would be desirable and highly advantageous to have a video codec to minimize the error propagation in a sequence of video pictures as to minimize the corruption of displayed video pictures.

### SUMMARY OF THE INVENTION

A method for constructing a sequence of video pictures is disclosed. A predictor picture for predicting a video picture in a video sequence is ignored when an error correction technique is used to construct the video picture. The invention applies information from other pictures in the sequence, as reference pictures, to predict the video picture being constructed. The other pictures representing a reference picture for predicting at least one region of the video picture.

### BRIEF DESCRIPTION OF THE DRAWINGS

FIG. 1 is a block diagram of an exemplary digital video receiving system that operates according to the principles of the invention is shown.

FIG. 2 is a sequence of video pictures, according to an illustrative embodiment of the invention.

FIG. 3 is a sequence of video pictures, according to an illustrative embodiment of the invention.

FIG. 4 is a block diagram illustrating the construction of a video picture from data representing a sequence of video pictures for a video decoding operation.

### DETAILED DESCRIPTION OF THE INVENTION

As used herein, multimedia related data that is encoded and is later transmitted represents a media object. The terms information and data are also used synonymously throughout the text of the invention as to describe pre or post encoded audio/video data. The term media object includes audio, video, textual, multimedia data files, and streaming media files. Multimedia files comprise any combination of text, image, video, and audio data. Streaming media comprises audio, video, multimedia, textual, and interactive data files that are delivered to a user's device via the Internet or other communications network environment and begin to play on the user's computer/device before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, the reduction in cost of communications networks through the use of high-bandwidth connections such as cable, DSL, T1 lines and wireless networks (e.g., 2.5 G or 3 G based cellular networks) are providing Internet users with speedier access to streaming media content from news organizations, Hollywood studios, independent producers, record labels and even home users themselves. Additionally, the term video decoding and constructing are analogous terms for creating or generating a region of a video picture, such as a block, from video data.

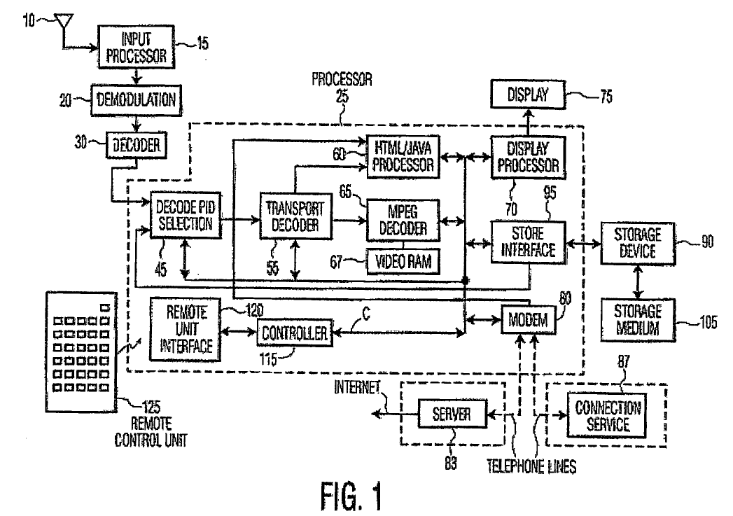

Referring to FIG. 1, a block diagram of an exemplary digital video receiving system that operates according to the principles of the invention is shown. The video receiver system includes an antenna 10 and input processor 15 for receiving and digitizing a broadcast carrier modulated with signals carrying audio, video, and associated data, a demodulator 20 for receiving and demodulating the digital output signal from input processor 15, and a decoder 30 outputting a signal that is trellis decoded, mapped into byte length data segments, de-interleaved, and Reed-Solomon error corrected. The corrected output data from decoder unit 30 is in the form of an MPEG compatible transport data stream containing program representative multiplexed audio, video, and data components. The video receiver system further includes a communication interface 80 that may be connected by telephone lines, Ethernet, cable, and the like to a server 83 or connection service 87 such that data in various formats (e.g., MPEG, HTML, and/or JAVA) can be received by the video receiver system over the telephone lines.

A processor 25 processes the data output from decoder 30 and/or modem 80 such that the processed data can be displayed on a display unit 75 or stored on a storage medium 105 in accordance with requests input by a user via a remote control unit 125. More specifically, processor 25 includes a controller 115 that interprets requests received from remote control unit 125 via remote unit interface 120 and appropriately configures the elements of processor 25 to carry out user requests (e.g., channel, website, and/or on-screen display (OSD)). In one exemplary mode, controller 115 configures the elements of processor 25 to provide MPEG decoded data and an OSD for display on display unit 75. In another exemplary mode, controller 115 configures the elements of processor 25 to provide an MPEG compatible data stream for storage on storage medium 105 via storage device 90 and store interface 95. In a further exemplary mode, controller 115 configures the elements of processor 25 for other communication modes, such as for receiving bidirectional (e.g. Internet) communications via server 83 or connection service 87.

Processor 25 includes a decode PID selection unit 45 that identifies and routes selected packets in the transport stream from decoder 30 to transport decoder 55. The transport stream from decoder 30 is demultiplexed into audio, video, and data components by transport decoder 55 and is further processed by the other elements of processor 25, as described in further detail below.

The transport stream provided to processor 25 comprises data packets containing program channel data, ancillary system timing information, and program specific information such as program content rating, program aspect ratio, and program guide information. Transport decoder 55 directs the ancillary information packets to controller 115 that parses, collates, and assembles the ancillary information into hierarchically arranged tables. Individual data packets comprising the user selected program channel are identified and assembled using the assembled program specific information. The system timing information contains a time reference indicator and associated correction data (e.g. a daylight savings time indicator and offset information adjusting for time drift, leap years, etc.). This timing information is sufficient for a decoder to convert the time reference indicator to a time clock (e.g., United States east coast time and date) for establishing a time of day and date of the future transmission of a program by the broadcaster of the program. The time clock is useable for initiating scheduled program processing functions such as program play, program recording, and program playback. Further, the program specific information contains conditional access, network information, and identification and linking data enabling the system of FIG. 1 to tune to a desired channel and assemble data packets to form complete programs.

Transport decoder 55 provides MPEG compatible video, audio, and sub-picture streams to MPEG decoder 65. The video and audio streams contain compressed video and audio data representing the selected channel program content. The sub-picture data contains information associated with the channel program content such as rating information, program description information, and the like.

MPEG decoder 65 cooperates with a random access memory (RAM) 67 to decode and decompress the MPEG compatible packetized audio and video data from unit 55 and provides decompressed program representative pixel data to display processor 70 as to form a sequence of video pictures and portions corresponding to such video pictures. Decoder 65 also assembles, collates and interprets the sub-picture data from unit 55 to produce formatted program guide data for output to an internal OSD module (not shown). The OSD module cooperates with RAM 67 to process the sub-picture data and other information to generate pixel mapped data representing subtitling, control, and information menu displays including selectable menu options and other items for presentation on display device 75. The control and information menus that are displayed enable a user to select a program to view and to schedule future program processing functions including tuning to receive a selected program for viewing, recording of a program onto storage medium 105, and playback of a program from medium 105.

The control and information displays, including text and graphics produced by the OSD module (not shown), are generated in the form of overlay pixel map data under direction of controller 115. The overlay pixel map data from the OSD module is combined and synchronized with the decompressed pixel representative data from MPEG decoder 65 under direction of controller 115. Combined pixel map data representing a video program on the selected channel together with associated sub-picture data is encoded by display processor 70 and output to device 75 for display.

The principles of the invention may be applied to terrestrial, cable, satellite, DSL, Internet or computer network broadcast systems in which the coding type or modulation format may be varied. Such systems may include, for example, non-MPEG compatible systems, involving other types of encoded data streams and other methods of conveying program specific information. Further, although the disclosed system is described as processing video data that is processed into a sequence of video pictures, this is exemplary only. The architecture of FIG. 1 is not exclusive. Other architectures may be derived in accordance with the principles of the invention to accomplish the same objectives.

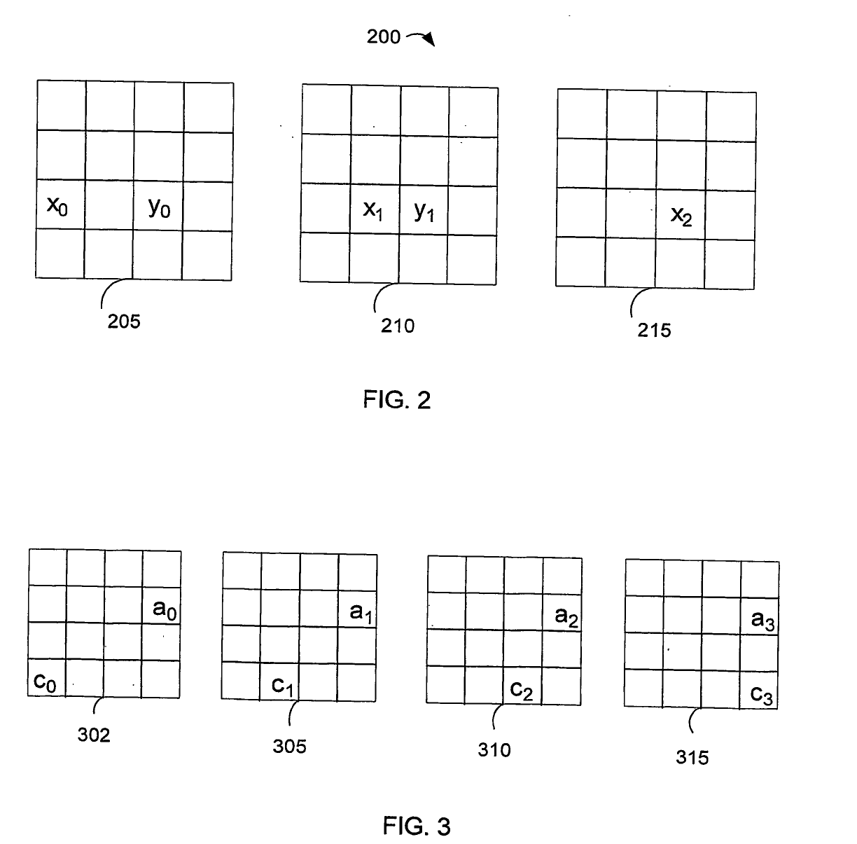

The preferred embodiment of the invention is explained in view of the I, B, and P pictures used for a video coding standard as MPEG-2, although it is to be appreciated that the concepts of the present invention apply to other video coding standards. As shown in FIG. 2, a sequence of video pictures 200 comprises picture 205 represent an I or P picture, picture 210 being a P picture, and picture 215 represents a P or B picture. Picture 215 is the current picture in a sequence of video pictures, where picture 215 is predicted from information from picture 210. Such predictions use prediction regions (such as blocks/regions from one picture) to predictively construct a block corresponding to a second picture of a sequence of video pictures.

A block section of picture 215, denoted with an X₂ is shown, where such an area is constructed from a region from picture 210 utilizing a motion vector corresponding to X₂, as known in the art. When the video data representing picture 210 was received, the video data contained errors where an error concealment technique was applied to conceal such errors. Different error concealment and error correction techniques are known in the art, as to be found in the article entitled “Error Concealment Algorithms for Robust Decoding of MPEG Compressed Video” written by Huifang Sun et al. as published in Signal Processing Image Communication 10 (1997) pages 249-268. In the present example, the block containing the X₁ in picture 210 was a block constructed in view of at least one error concealment technique.

The present invention introduces the concept of producing an error map that is stored in memory that keeps track of blocks and segments of a video picture that are received in error. When picture 210 is constructed using error concealment techniques, the blocks that were fixed by error concealment techniques are denoted in such a map. The map may exist as an array where the coordinates of the error corrected/concealed blocks are stored in decoder 65 by their coordinates such as (i, j) in the picture and by the order number of the picture as in the sequence of video pictures. Those skilled in the art will appreciate other implementations to store such error map information.

When picture 215 is constructed, the map is consulted where a determination is made if the block currently being constructed is predictably constructed in view of a predictor region (such as a block) that was previously error concealed in picture 210. If the block region was previously error concealed from picture 210, as denoted with block Y₁, information from another video picture, such as picture 205, is used to construct the affected block of picture 215. Hence, the information to construct the block denoted with an X₂ in picture 215 uses information from the block region denoted with Y₀ in picture 205 as a predictor block instead of Y₁ from picture 210. For purposes of the invention, the regions of a picture capable of being used as predictor region described in this disclosure may take the form of blocks, macroblocks, circles, or any other polygon required to implement the principles of the invention.

In the present invention, a block denoted with an X₁ in picture 210 represents a region that was constructed in view of an error concealment technique, where information indicating such an error is recorded in the error map.

When constructing a block in view of a corresponding motion vector, an embodiment of the invention considers whether the predictor block supposed to be used to constructively predict the constructed block was impacted by an error concealment operation, For example, block X₂ in picture 215 has a corresponding motion vector where block X₂ is supposed to be generated in view of the motion vector and predictor block X₁ of picture 210. The invention consults with the error map to determine if block X₁ of picture 210 was constructed by using an error concealment operation. If this case is true, the invention will utilize information from block X₀ and the motion vector to construct block X₂. If not, the invention will use information derived from picture 210 to construct block X₂. In a preferred embodiment of the invention, the motion vector corresponding to a block (such as X₂) is scaled in relation to the distance of the picture corresponding to the block being constructed (X₂) and the reference picture from which the block (X₀) is used to modify the motion vector. Any other method of scaling such motion vectors may be used in accordance with the principles of the present invention. The term ‘distance’ is known in the art as from MPEG-2 as to describe the relative temporal reference values between two pictures in a sequence of pictures.

In an alternative embodiment of the present invention, the invention excludes the use of the picture as a reference picture if a predetermined number corresponding to the number of errors is exceeded when constructing such a reference picture. Hence, in the present invention, if picture 210 contains a number of blocks that were produced in view of error concealment techniques, the construction of picture 215 would utilize video information from picture 205 as a predictor region instead of the predictor region that was supposed to be used from picture 210.

The invention alternatively could also use pictures 205 and 21.0 as a reference pictures for picture 215, where a boundary-smoothing test, such a test is known in the art, is used to determine which reference picture produces a better result when constructing a block corresponding to picture 215. The reference picture with the better result is used as the basis for constructing the block for picture 215

When using weighting factors to construct pictures from each other, the invention may scale such a weighting factor in view of the relative distance between an error concealed picture and the picture being constructed versus a selected reference picture and the picture being constructed. In the illustrative embodiment of the present invention, picture 210 uses error concealment techniques to construct the picture. Hence, when picture 215 is produced, a weighting factor for picture 210 is used and scaled based on the relative distances between picture 215 and picture 210 compared to the distance from picture 205 (used as the reference picture because picture 210 has errors) to the distance of picture 215.

The principles of the present invention apply when performing a bipredictive coding operation to construct video pictures. Referring to FIG. 3, a sequence of video pictures 300 is presented with pictures 305 and 315 being an I, P or B picture, and picture 310 being a B picture. In the present example, picture 310 is constructed using information from pictures 305 and 315. In the case where a region of picture 305 was constructed using an error concealment technique (block A₁ in the picture 305), the invention utilizes information from picture 315 as the reference picture (block A₃) to predict an applicable region of picture 310 (block A₂). The principles of this embodiment of the present invention also apply where picture 305 is used to predict picture 310, when error concealment techniques are used for constructing picture 315. In this case the invention would predictively construct a block for picture 310 in view of picture 305, not picture 315.

An alterative embodiment of the invention exists for constructing a bipredictive picture from other pictures sequence of video pictures. Referring to FIG. 3, picture 305 had a region of the picture constructed using error concealment techniques. Block C₁ of picture 305 is the region of the picture impacted by the error concealment operation. When constructing picture 310, this illustrative embodiment of the invention uses information from the previous picture in front of picture 305, in this case picture 302 that is either an I, B, or P picture. Hence, two predictors are averaged to construct block C₂ of bipredictive picture 310 by adjusting the motion vector corresponding to block C₂ in view of a block C₀ from picture 302 and using the normal predictor from picture 315, from block C₃.

When choosing between the two listed embodiments for constructing a B type picture, the weighting factors for both pictures 305 and 315 may be considered for deciding which technique yields better results. If the weighting factor for picture 315 is larger than the weighting factor for picture 305, a corresponding block from picture 315 alone is used as the predictive block for generating the corresponding block of picture 310. Otherwise, picture 310 is constructed bi-predictively by using a corresponding block of picture 302 instead of picture 305 with the appropriately scaled weighting factor being applied with the normal use of the corresponding block of picture 315.

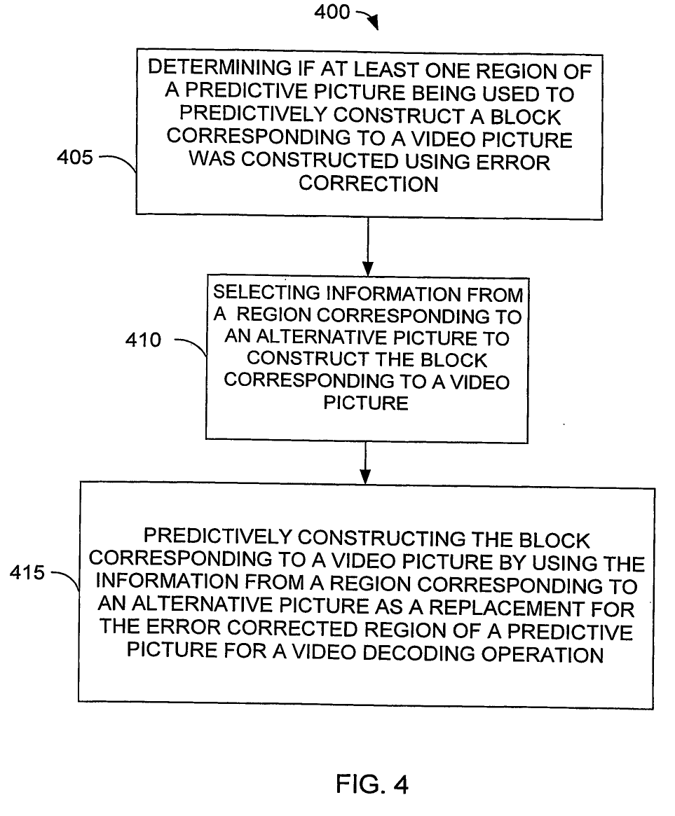

FIG. 4 shows an illustrative embodiment of a block diagram for constructing a video picture from data representing a sequence of video pictures, as described above. Step 405 performed by decoder 65 determines if a region (such as a block) corresponding to a predictive picture that will be used to construct a block corresponding to a video picture was constructed by use of an error concealment or error correction technique. Decoder 65, for example, could use the error map described above to achieve such an operation, although any of the techniques described above may be used. The block being considered to be constructed in this example may have a shape that is not square, for example the block may actually be rectangular, circular, or any other type of polygon shape, depending on the requirements of the video standard for constructing such as block. For example, the generation of a region of picture 210 that was to be used to generate a corresponding block of picture 215 (as a predictor region) required error concealment when such a region was constructed.

If true, step 410 then has decoder 65 select an alternative picture from the sequence of video pictures to be used as a reference picture to predictively construct the block corresponding to the video picture. This may have the invention selecting a picture either before or after the video picture in order to predictively construct a block. Such a determination may be done in terms of the embodiments described above. In the present example, picture 205 is selected as an alterative picture and an alternative predictor region will be selected from said alternative picture.

Step 415 then is the actual construction of the block corresponding to the video picture by using the video data corresponding to the reference picture as a replacement for the regions of the predictive picture that were constructed using an error concealment/correction operation. Hence, decoder 65 uses regions such as blocks from the reference picture as an alternative predictor region to construct corresponding regions of the video picture, instead of regions of the predictive picture. Completing the present example, a region of picture 205 is used to predictively construct the block corresponding to the video picture instead of the region from picture 210 that was error corrected. If a picture is bi-predictively encoded, a second alternative picture may be used in the predictive decoding process, in accordance with the principles described above.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

1. A method for constructing a video picture block from video data representing a sequence of video pictures comprising the steps of:
determining region of a predictive picture that was constructed by using error correction;
selecting an alternative picture from said sequence of video pictures as a reference picture to predictively construct said block; and
constructing said video picture block using data from said reference picture to replace said region.

2. The method of claim 1, wherein said region corresponds to at least one of: a block, macroblock, and polygon.

3. The method of claim 1, wherein said determining step uses an error map to determine said region of a predictive picture that was constructed by error correction.

4. The method of claim 3, wherein said constructing step modifies a motion vector for said video block by using information from a block from said reference picture and scaling said motion vector in view of said block from said reference picture.

5. The method of claim 1, wherein said constructing step uses a block from said reference picture to replace a block from the predictive picture that was constructed by error correction; and said block from said reference picture is used as a basis for a predicatively constructing said video picture block.

6. The method of claim 5, wherein said predictive operation is associated with the construction of a B picture from a reference picture selected from at least one of: a B picture, a P picture, and an I picture.

7. The method of claim 1, wherein said reference picture is sequentially before said predictive picture in said sequence of video pictures.

8. The method of claim 7, wherein said construction step modifies a motion vector corresponding to said block of said video picture by using information from a block from said reference picture and scaling said motion vector, said motion vector is determined by scaling said motion vector depending on the distance between said video picture and said reference picture utilizing the relative temporal reference values of the corresponding pictures in said sequence of pictures.

9. The method of claim 1, wherein a region from said reference picture is used as a predictor for constructing said video picture when a number of errors is exceeded when error correcting said predictive picture.

10. The method of claim 1 comprising the additional steps of:
performing a boundary smoothing test for testing the use of said reference picture for constructing said video picture; performing a boundary smoothing test for testing the use of said predictive picture for constructing said video picture; and
selecting data from either said predictive picture or said reference picture in view of the results from said boundary smoothing test.

11. The method of claim 1, wherein said construction step uses a weighting factor to predictively construct said video picture, said weighting factor being changed from corresponding to said predictive picture to said reference picture.

12. The method of claim 1, wherein said construction step uses a weighting factor to predictively construct said video picture, said weighing factor being calculated from a weighting factor based on said predictive picture; and
said weighting factor is scaled based on relative distance between said predictive picture and said video picture in said sequence of video pictures to the relative distance between said reference picture and said video picture in said sequence of video pictures.

13. The method of claim 1, wherein
said video picture is a bi-predictively encoded picture using data from said reference picture and said predictive picture, and
said construction step is a decoding operation using data from said reference picture instead of data from said predictive picture.

14. The method of claim 1, wherein
said video picture is a bi-predictively encoded picture using data from said reference picture and said predictive picture,
said video picture block has a motion vector related to itself where said region of said predictive picture is used with said motion vector to construct said video picture block,
region from an second alternative picture is used to adjust said motion vector corresponding to said video picture block; and
said data representing a predictor region from the reference picture and said adjusted motion vector are used to predictively construct said block being constructed.

15. Apparatus for constructing a video picture block from video data representing a sequence of video pictures in a decoding operation, comprising:
a means for determining a region of a predictive picture that was constructed by using error correction where such a region is to be used as a predictive region for constructing said video picture block;
a means for selecting an alternative picture from said sequence of video pictures as a reference picture to predictively construct said video picture block; and
a means for predictively constructing said video picture block using data corresponding to said reference picture as a replacement for said region of the predictive picture that was constructed using error correction.
